(19) United States
(12) Patent Application Publication
(10) Pub. No.: US 2012/0212155 A1
(43) Pub. Date: Aug. 23, 2012

(54) LED LAMP MODULE WITH ADDRESS GENERATION FUNCTIONS

(76) Inventors: Lin Cheng-Lung, Jhubei City (TW); Lin Che-Chuan, Jhubei City (TW)

(21) Appl. No.: 13/032,770

(22) Filed: Feb. 23, 2011

(51) Int. Cl. H05B 37/02

(52) U.S. Cl. 315/312

(57) ABSTRACT

The present invention relates generally to a kind of LED lamp module with address generation functions, which comprises: At least one light-emitting diode (LED); a plurality of pins comprising one power pin, one grounding pin, one signal input pin and one Analog-to-Digital Converter (ADC) input pin etc., in which, the said power pin is being electrically connected to one power supply, the said grounding pin is being electrically connected to one grounding; one Analog-to-Digital Converter (ADC), which is being electrically connected to the said ADC input pin; one control unit, which is being electrically connected to the said signal input pin, the said light-emitting diode as well as the said ADC; and wherein, the said ADC is capable of converting an analog voltage value at the said ADC input pin into a digital voltage value, and then delivering it to the said control unit, and in addition, while responding to the said digital voltage value, the said control unit will generate one specific address, so that the said control unit will be able to control the illumination of the said LED in accordance with the said address and one signal received by the said signal input pin.

### BACKGROUND OF THE INVENTION

1. Field of the Invention

The present invention relates generally to a kind of LED lamp module with address generation functions, and more specifically it relates to a LED lamp module with address generation functions that is able to convert an analog voltage at one node into a digital voltage value by means of an Analog-to-Digital Converter (ADC), and then it will determine a specific address for the said module pursuant to the said digital voltage value thereof.

2. The Prior Art

The known LED lamp has several features, such as high illuminating efficiency, long service life and low power consumption etc., therefore, LED lamps have already dramatically replaced traditional light bulbs in recent years, and meanwhile it has been widely applied to various decorative light string markets. FIG. 1 is a schematic view showing a known LED lamp module, wherein, it comprises red light-emitting diode 11, green light-emitting diode 12, blue light-emitting diode 13, control unit 14, LED lamp module 15 and input end of sync signal 16 etc. The known LED lamp module 15 consists of red light-emitting diode 11, green light-emitting diode 12, blue light-emitting diode 13 and control unit 14. Whereby, control unit 14 is being electrically connected with red light-emitting diode 11, green light-emitting diode 12 and blue light-emitting diode 13 respectively, which can independently control and make each light-emitting diode illuminating, flashing, selecting color combinations and/or changing colors respectively. Additionally, the control unit 14 is being further electrically connected to the input end of sync signal 16 in order to control the operation of light-emitting diode 11, 12, or 13 while responding to the sync signals received by the signal input of sync signal 16.

Upon the application for the light strings, a plurality of known LED lamps 15 are cascaded all together, in which, the input end of sync signal 16 of each LED lamp module 15 is being connected to the control center, so that the control center will be able to control and make each the light strings illuminating, flashing and/or changing colors while transferring sync control signals to input end of sync signal 16 of the said LED lamp module 15. However, the above-mentioned operational mode only can control the light strings consisting of the known LED lamp module 15 to operate synchronously, and it is impossible to addressing control the operation of each individual LED lamp module 15 to execute the special effects for the light strings, such as marquee or specific arrangement of texts and images in order to meet special requirements.

Since the known LED lamp module 15 does not have any dynamically address-generating function, therefore, once an operator is trying to address each LED lamp module 15, the said operator must pre-write each specific address into each corresponding LED lamp module 15 respectively, so that it is able to successfully control each individual LED lamp module 15 with pre-write address. However, there seems to be a lack of flexibility while using pre-write addresses to configure relevant circuit modules and moreover, it is impossible to change the pre-write addresses to meet the future needs. Furthermore, when it is being applied to light strings, the control center will be unable to accurately control each LED lamp module 15 unless it can record the corresponding information related to the location and address allocated for each LED lamp module 15 in advance, and under this circumstance, not only the relevant operations will become more complicated, but also it has to raise a lot of hardware costs in addition to extra memory spaces.

The disadvantages of the known technique are as follows:

1. The known LED lamp module does not have any dynamically address-generating function at all;

2. The known LED lamp module seems to be a lack of flexibility while using pre-write addresses to control each individual circuit module; and

3. Whenever the known LED lamp module is being applied to the light strings, its control center must record the corresponding information related to the location and address allocated for each LED lamp module, so that it must waste a lot of money on hardware costs due to a complicated allocation operation and extra memory spaces.

Thus, how to improve above-mentioned disadvantages of the known technique to make LED lamp module having a dynamically address-generating function seems to be a major concern for the present invention.

### SUMMARY OF THE INVENTION

The purpose of this invention lies in providing a novel and advanced LED lamp module with address generation functions, in which, each lamp module has being installed with an Analog-to-Digital Converter (ADC), so that it is able to convert an analog voltage value at one node into a digital voltage value by means of an Analog-to-Digital Converter (ADC) and also transferring it to one control unit, and in this way it will be able to successfully generate a corresponding address according to the said digital voltage value thereof.

In order to fulfill the above specific purposes, the present invention, therefore, presents a kind of LED lamp module with address generation functions, which comprises:

At least one light-emitting diode (LED);

A plurality of pins, which comprise one power pin, one grounding pin, one signal input pin and one Analog-to-Digital Converter (ADC) input pin, and the said power pin is being electrically connected to one power supply, the said grounding pin is being electrically connected to one grounding;

One Analog-to-Digital Converter (ADC), which is being electrically connected to the said ADC input pin;

One control unit, which is being electrically connected to the said signal input pin, the said LED and the said ADC respectively;

Wherein, the said ADC can convert an analog voltage value at the said ADC input pin into a digital voltage value, and then delivering it to the said control unit, in addition, while responding to the said digital voltage value, the said control unit will generate one specific address, so that the said control unit will be able to control the illumination of the said LED in accordance with the said address and one signal received by the said signal input pin.

The LED lamp module with address generation functions as defined in the preceding paragraphs, in which, each LED lamp module comprises one red light-emitting diode, one green light-emitting diode and one blue light-emitting diode, and thereat, the said control unit is being electrically connected with the said red light-emitting diode, the said green light-emitting diode and the said blue light-emitting diode respectively, and in this way, it will be able to control the said red light-emitting diode, the said green light-emitting diode and the said blue light-emitting diode respectively, to make it illuminating, flashing and/or changing colors.

The LED lamp module with address generation functions as defined in the preceding paragraphs, wherein, it further comprises one memory unit being electrically connected to the said control unit, and meanwhile it can be used to store the said address.

Again, the present invention further presents a kind of LED lamp module with address generation functions, which comprises:

At least one light-emitting diode (LED);

A plurality of pins that comprise one power pin, one grounding pin, one signal input pin, one primary ADC input pin and one secondary ADC input pin, and thereat, the said power pin is being electrically connected to one power supply, and the said grounding pin is being electrically connected to one grounding;

One primary Analog-to-Digital Converter (ADC), which is being electricity connected to the said primary ADC input pin;

One secondary Analog-to-Digital Converter (ADC), which is being electricity connected to the said secondary ADC input pin;

One control unit, which is being electrically connected to the said signal input pin, the said LED, the said primary ADC and the said secondary ADC respectively;

One resistance, which is being electrically connected to the said primary ADC input pin and the said secondary ADC input pin respectively;

Wherein, the said primary Analog-to-Digital Converter (ADC) is able to convert one primary analog voltage value on the said primary ADC input pin into one primary digit voltage value, and then delivering it to the said control unit; and in addition, the said secondary Analog-to-Digital Converter (ADC) is able to convert one secondary analog voltage value on the said secondary ADC input pin into one secondary digit voltage value, and then delivering it to the said control unit, and moreover, while responding to the said primary digital voltage value and the said secondary digital voltage value, the said control unit will generate one specific address, so that the said control unit will be able to control the illumination of the said LED in accordance with the said address and one signal received by the said signal input pin.

### BRIEF DESCRIPTION OF THE DRAWING

The present invention will be apparent to those skilled in the art by reading the following detailed description of a preferred embodiment thereof, with reference to the attached drawings, in which:

FIG. 1 is a schematic view of a known LED lamp module;

FIG. 2 is a schematic view showing a preferred embodiment of LED lamp module with address generation functions in accordance with the present invention;

FIG. 3 is a schematic view showing a preferred embodiment of LED lamp module with address generation functions, which is being applied to light strings, in accordance with the present invention;

FIG. 4 is a schematic view showing another preferred embodiment of LED lamp module with address generation functions in accordance with the present invention; and

FIG. 5 is a schematic view showing another preferred embodiment of LED lamp module with address generation functions, which is also being applied to the light strings, in accordance with the present invention.

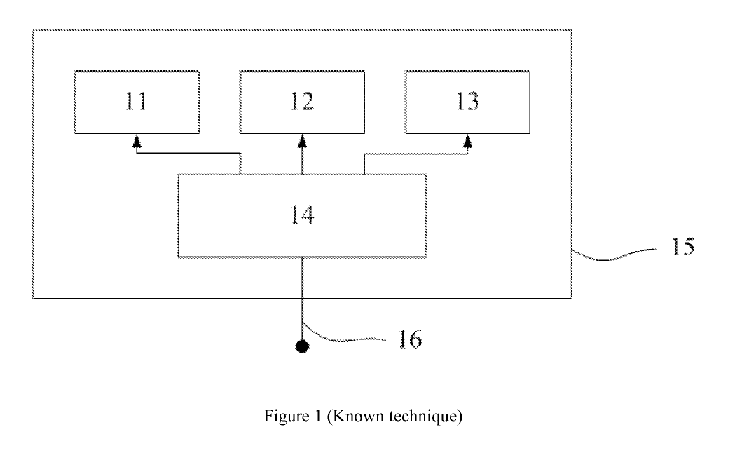

### DETAILED DESCRIPTION OF THE PREFERRED EMBODIMENT

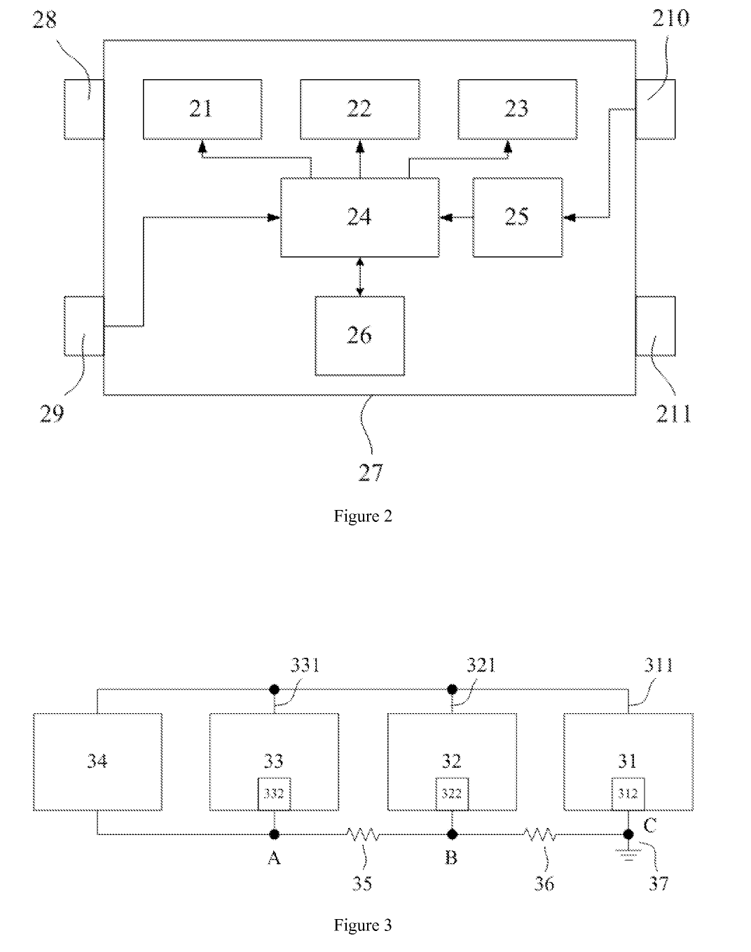

With reference to FIG. 2, it is a schematic view showing a preferred embodiment of LED lamp module with address generation functions in accordance with the present invention, in which, it comprises the red light-emitting diode 21, green light-emitting diode 22, blue light-emitting diode 23, control unit 24, Analog-to-Digital Converter (ADC) 25, memory unit 26, LED lamp module 27, power pin 28, signal input pin 29, ADC input pin 210 and grounding pin 211 etc. The LED lamp module 27 consists of red light-emitting diode 21, green light-emitting diode 22, blue light-emitting diode 23, control unit 24, Analog-to-Digital Converter (ADC) 25 and memory unit 26, and it further comprises the power pin 28, signal input pin 29, ADC input pin 210 and grounding pin 211. Moreover, the LED lamp module 27 is being electrically connected with one power supply via the said power pin 28 and the grounding pin 211 is being electricity connected to the ground.

The control unit 24 is being electrically connected to the red light-emitting diode 21, green light-emitting diode 22, blue light-emitting diode 23, Analog-to-Digital Converter (ADC) 25 and memory unit 26 respectively, and thereby, it is able to individually control each LED to make it illuminating, flashing, mixing colors and/or changing colors. The Analog-to-Digital Converter (ADC) 25 can convert one analog voltage value on the ADC input pin 210 into one digit voltage value, and then delivering it to the said control unit 24, and moreover, while responding to the said digital voltage value, the said control unit 24 will generate one corresponding address and also to store the said address in the said memory unit 26. Therefore, while LED lamp module 27 is receiving one addressing command through the signal input pin 29, it will follow the above-mentioned method to generate one corresponding address pursuant to the voltage value on the ADC input pin 210, and in this way, it will make the said control unit 24 be able to control the illumination of the red light-emitting diode 21, green light-emitting diode 22, or blue light-emitting diode 23.

FIG. 3 is a schematic view showing a preferred embodiment of LED lamp module with address generation functions, which is being applied to light strings, in accordance with the present invention, in which, it comprises the LED lamp module 31, 32, 33, the signal input pin 311, 321, 331, Analog-to-Digital Converter (ADC) 312, 322, 332, control center 34, resistance 35, 36 as well as the grounding 37. Whereby, after the signal input pin 311, 321, 331 of LED lamp module 31, 32, 33 has received relevant addressing commands from the control center 34, the LED lamp module 31, 32, 33 will convert, through Analog-to-Digital Converter (ADC) 312, 322, 332, the analog voltage value at Point A, B, C, into digital voltage value respectively, and hence generating corresponding addresses accordingly. Due to the voltage on Point A output by the said control center 34 will create a voltage drop at the resistance 35 and 36, therefore, the voltage value created on Point A, B or C is varied, and under this circumstance, it will hence generate different address for the LED lamp module 31, 32, 33. For example: when resistance 35 and 36 has a same resistance value, supposed the control center 34 outputs 2V voltage to Point A, then the relative voltage value created at Point A, B or C will be 2V, 1V or 0V respectively. Therefore, Analog-to-Digital Converter (ADC) 332, 322, 312 will convert the analog voltage value of 2V, 1V and 0V into corresponding digital voltage value and then delivering it to each individual control unit respectively, so as to accomplish the addressing operation by making the control unit on LED lamp module 33, 32, 31 to generate different address 2, 1 and 0 respectively. Thus, after the completion of addressing operation, the said control center 34 will be able to further control the illuminating effects of specific LED lamp module just by simply adding address information into each control signal.

Certainly, it is allowable to make the control center 34 outputting varied voltage values, also to adopt different resistance values for the resistance 35 and 36 resistivity, and instead, at one end of resistance 36 that is being connected to one end of ADC 312 originally. Besides, it is allowable to increase more units of LED lamp modules as well as the corresponding resistances.

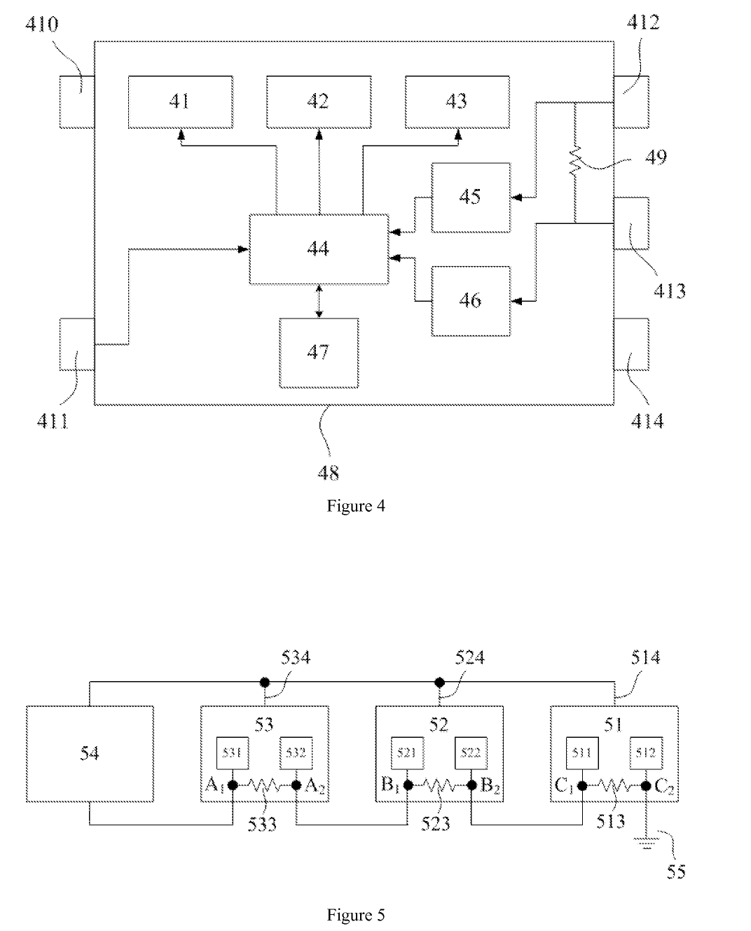

FIG. 4 is a schematic view showing another preferred embodiment of LED lamp module with address generation functions in accordance with the present invention, wherein, it comprises the red light-emitting diode Wherein 41, green light-emitting diode 42, blue light-emitting diode 43, control unit 44, Analog-to-Digital Converter (ADC) 45, 46, memory unit 47, LED lamp module 48, resistance 49, power pin 410, signal input pin 411, ADC input pin 412, 413 and grounding pin 414 etc. While comparing these two diagrams, it can be found that the largest difference in the structure pursuant to FIG. 4 is that it adopts two sets of Analog-to-Digital Converter (ADC) 45, 46, and in addition, one additional resistance 49 has been installed at a position between the two ADC inputs pin 412 and 413, an in this way, one LED lamp module 48 will be able to identify its existing address line by means of the voltage difference between ADC input pin 412 and 413 as well as individual voltage value.

With reference to FIG. 5, it is a schematic view showing another preferred embodiment of LED lamp module with address generation functions, which is being applied to the light strings, in accordance with the present invention, it comprises LED lamp module 51, 52, 53, Analog-to-Digital Converter (ADC) 511, 512, 521, 522, 531, 532, resistance 513, 523, 533, signal input pin 514, 524, 534, control center 54 and grounding 55 respectively. Supposed that resistances 513, 523, 533 all adopt a same resistance value, and if the control center 54 is outputting one 3V voltage, and under this circumstance, the relative voltage at each point will be: Point A1—3V, Point A2—2V, Point B1—2V, Point B2—1V, Point C1—1V and Point C2—0V. For instance, one LED lamp module 52, therefore, the said LED lamp module 52 is able to identify the existing address for each LED lamp module, which has a voltage difference value of 1V, by way of the voltage difference of 1V between Point B1 and B2, and in addition, it also can easily infer a conclusion that there are three sets of LED lamp modules in total by means of the output voltage value of 3V and the voltage value of 2V at Point B1, and thereby it can also indentify its existing address line to be the position 2nd.

The advantages of the present invention are as follows:

1. The LED lamp module with address generation functions provided in accordance with the present invention can dynamically generate specific addresses by way of detecting the voltage value on relevant nodes;

2. The addressing operation for the LED lamp module with address generation functions provided in accordance with the present invention need not to pre-write any address at all, it can be executed in a very flexible way, that is, the corresponding addresses can be generated only after the completion of the configuration operation for relevant LED lamp modules;

3. Upon the application of the light strings, there is no need at all for the control center of LED lamp module with address generation functions provided in accordance with the present invention to record the allocated address along with corresponding information of its allocated address for each LED lamp module, and in this way, not only its installation operation will become much more easier, but also it can save a lot of hardware costs without extra memory spaces; and

4. While using two sets of ADC, the LED lamp module with address generation functions provided in accordance with the present invention can make each LED lamp module to easily infer the sum of LED lamp modules used in the light strings and its existing position by means of the voltage value detected by it.

From the foregoing description, it can be found that the LED lamp module with address generation functions provided in accordance with the present invention is able to dynamically generate specific addresses by way of voltage values detected on relevant nodes, which is deemed to be a novel, advanced and practical method, whereas, all modifications and changes including various applications, different designs for the circuit module, such as, using more additional sets of circuit modules or even to generate addresses through various algorithm etc., any similar structure consisting of a plurality of circuit modules and to generate specific addresses in turn for the said circuit modules may be made without departing from the scope of the present invention at all.

Although the present invention has been described with reference to the preferred embodiment that can be achieved easily by a skillful person familiar with this particular technology thereof, it is apparent to those skilled in the art that a variety of modifications and changes may be made without departing from the scope of the present invention which is intended to be defined by the appended claims.

What is claimed is:

1. An LED lamp module with address generation functions, which comprises:
at least one light-emitting diode (LED);
a plurality of pins, which comprise one power pin, one grounding pin, one signal input pin and one Analog-to-Digital Converter (ADC) input pin, and the said power pin is being electrically connected to one power supply, the said grounding pin is being electrically connected to one grounding;
one analog-to-Digital Converter (ADC), which is being electrically connected to the said ADC input pin;
one control unit, which is being electrically connected to the said signal input pin, the said LED and the said ADC respectively; and
wherein, the said ADC can convert an analog voltage value at the said ADC input pin into a digital voltage value, and then delivering it to the said control unit, in addition, while responding to the said digital voltage value, the said control unit will generate one specific address, so that the said control unit will be able to control the illumination of the said LED in accordance with the said address and one signal received by the said signal input pin.

2. An LED lamp module with address generation functions as claimed in claim 1, wherein, the said LED lamp module comprises one red light-emitting diode, one green light-emitting diode and one blue light-emitting diode, and thereat, the said control unit is being electrically connected with the said red light-emitting diode, the said green light-emitting diode and the said blue light-emitting diode respectively, and in this way, it will be able to control the said red light-emitting diode, the said green light-emitting diode and the said blue light-emitting diode respectively, to make it illuminating, flashing and/or changing colors.

3. An LED lamp module with address generation functions as claimed in claim 1, wherein, it further comprises one memory unit, which is being electrically connected to the said control unit, and meanwhile it can be used to store the said address.

4. An LED lamp module with address generation functions, which comprises:
at least one light-emitting diode (LED);
a plurality of pins that comprise one power pin, one grounding pin, one signal input pin, one primary ADC input pin and one secondary ADC input pin, and thereat, the said power pin is being electrically connected to one power supply, and the said grounding pin is being electrically connected to one grounding;
one primary Analog-to-Digital Converter (ADC), which is being electricity connected to the said primary ADC input pin;
one secondary Analog-to-Digital Converter (ADC), which is being electrically connected to the said secondary ADC input pin;
one control unit, which is being electrically connected to the said signal input pin, the said LED, the said primary Analog-to-Digital Converter (ADC) and the said secondary Analog-to-Digital Converter (ADC) respectively;
one resistance, which is being electrically connected to the said primary ADC input pin and the said secondary ADC input pin respectively; and
wherein, the said primary Analog-to-Digital Converter (ADC) is able to convert one primary analog voltage value on the said primary ADC input pin into one primary digit voltage value, and then delivering it to the said control unit; and in addition, the said secondary Analog-to-Digital Converter (ADC) is able to convert one secondary analog voltage value on the said secondary ADC input pin into one secondary digit voltage value, and then delivering it to the said control unit, and moreover, while responding to the said primary digital voltage value and the said secondary digital voltage value, the said control unit will generate one specific address, so that the said control unit will be able to control the illumination of the said LED in accordance with the said address and one signal received by the said signal input pin accordingly.

5. An LED lamp module with address generation functions as claimed in claim 4, wherein, the said LED lamp module comprises one red light-emitting diode, one green light-emitting diode and one blue light-emitting diode respectively, and thereat, the said control unit is being electrically connected to the said red light-emitting diode, the said green light-emitting diode and the said blue light-emitting diode respectively, and in this way, it will be able to control the said red light-emitting diode, the said green light-emitting diode and the said blue light-emitting diode respectively, to make it illuminating, flashing and/or changing colors.

6. An LED lamp module with address generation functions as claimed in claim 4, wherein, it further comprises one memory unit, which is being electrically connected to the said control unit, and meanwhile it can be used to store the said address.
